(19) United States
(12) Patent Application Publication
(10) Pub. No.: US 2015/0215330 A1
(43) Pub. Date: Jul. 30, 2015

(54) METHODS AND SYSTEMS OF CONTROLLING DISTRIBUTION OF PERSONAL DATA OVER NETWORK(S)

(71) Applicant: Shine Security Ltd., Herzlia Pituach (IL)

(72) Inventors: Itay KATZ, RaAnana (IL); Doron SHAMIA SADEH, Givataim (IL)

(21) Appl. No.: 14/608,371

(22) Filed: Jan. 29, 2015

Related U.S. Application Data
(60) Provisional application No. 61/933,366, filed on Jan. 30, 2014.
(60) Provisional application No. 61/942,049, filed on Feb. 20, 2014.

(51) Int. Cl. H04L 29/06

(52) U.S. Cl. CPC H04L 63/1416

(57) ABSTRACT

A method of blocking or editing network traffic events on a client terminal. The method monitoring, in run time, a plurality of network traffic events triggered by a plurality of applications executed on a client terminal for transmitting data via a cellular network, analyzing the plurality of network traffic events to identify thereamong at least one advertisement network traffic event for transferring personal data which describe at least one characteristic of a user associated with the client terminal over a network, and performing at least one of blocking and editing the at least one advertisement network traffic event to prevent transmitting of the personal data via the cellular network.

### RELATED APPLICATIONS

This application claims the benefit of priority under 35 USC 119(e) of U.S. to Provisional Patent Application Nos. 61/933,366 filed Jan. 30, 2014 and 61/942,049 filed Feb. 20, 2014, the contents of which are incorporated herein by reference in their entirety.

### BACKGROUND

The present invention, in some embodiments thereof, relates to network uplink transmission management and, more specifically, but not exclusively, to systems and methods of network traffic events management at the client terminal level.

A significant portion of data traffic in cellular networks in general and a significant portion of the causes for frequent signaling is attributed to processes for acquiring personal data for promotional purposes, for example for selecting advertisements and/or promotional landing pages. Such traffic includes sensitive information and in-application advertisements which are gathered by applications installed in cellular phones. For example, the traffic is originated from applications that embed advertisement elements. As a consequence, even applications that require no data connection may periodically trigger network events.

Signaling in cellular networks is the action carried out by a client terminal, an end device, and a base station subsystem (BSS) and the Network switching subsystem (NSS) of a cellular network for exchanging data between the client terminal and the cellular network. These signals are used to change the states of the cellular device with relation to the network, for example, a device may have open data channels, may be in low power mode, or can be idle with respect to the cellular network.

Signaling for cellular network resources originated from applications executed by the client terminal requires opening and closing data connections between the client terminal and the cellular network, for example the BSS and the NSS. The requirement of the action of opening and closing data connections for signaling may not be directly correlated with the actual amount of data requested from the cellular network by a network traffic event triggering the action of opening and closing data connections for signaling.

### SUMMARY

According to some embodiments of the present invention, there is provided a method of blocking or editing network traffic events on a client terminal. The method comprises monitoring, in run time, a plurality of network traffic events triggered by a plurality of applications executed on a client terminal for transmitting data via a cellular network, analyzing the plurality of network traffic events to identify thereamong at least one undesired network traffic event for transferring personal data which describe at least one characteristic of a user associated with the client terminal over a network, and performing at least one of blocking and editing the at least one undesired network traffic event to prevent transmitting of the personal data via the cellular network.

Optionally, the at least one undesired network traffic event is a network traffic event for triggering the transmission of the personal data in an advertisement request.

Optionally, the plurality of network traffic events are messages for opening a data connection over a cellular network.

Optionally, the client terminal is a cellular device and the network is a cellular network.

Optionally, the at least one undesired network traffic event is blocked by capturing packets of the at least one undesired network traffic event before the transmission thereof.

Optionally, the personal data comprises at least one of a name of the user, cellular identity data of the user, browsing data of the user, and cookie based data.

More optionally, the method further comprises analyzing a context of each of the plurality of network traffic events by identifying an activity the user on the client terminal; wherein the identifying is performed according to the context.

More optionally, the method further comprises analyzing a context of each of the plurality of network traffic events by identifying a predefined pattern of data consumption by the client terminal; wherein the identifying is performed according to the context.

Optionally, the identifying is performed according to a classification list which includes a plurality of records each the record defines at least one of a communication protocol classification, an application classification, and a traffic event classification.

Optionally, the identifying is performed according to a statistical classifier.

Optionally, the at least one undesired network traffic event is edited to conceal the personal data before the transmission thereof.

Optionally, the method further comprises establishing an artificial connection alive to maintain communication channel designated for transmitting the at least one undesired network traffic event alive.

According to some embodiments of the present invention, there is provided a device of blocking or editing network traffic events on a client terminal. The device comprises a monitoring module which monitors, in run time, a plurality of network traffic events triggered by a plurality of applications executed on a client terminal for transmitting data via a cellular network, an analysis module which analyzes the plurality of network traffic events to identify thereamong at least one undesired network traffic event comprising personal data characterizing a user of the client terminal as the data, and a network traffic event handling module which performs at least one of blocking and editing the at least one undesired network traffic event to prevent transmitting of the user defining data via the cellular network.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of blocking, editing, or delaying one or more network traffic events at a client terminal, according to some embodiments of the present invention;

FIG. 2 is a schematic illustration of a system of blocking, editing and/or delaying network traffic events with personal data at the client terminal level, according to some embodiments of the present invention; and

FIG. 3 is a dataflow wherein a network traffic event, marked as a network event, is captured, analyzed and either ignored or handled as a network traffic event having personal data about the user of the client terminal, according to some embodiments of the present inventions.

### DETAILED DESCRIPTION

The present invention, in some embodiments thereof, relates to network uplink transmission management and, more specifically, but not exclusively, to systems and methods of network traffic events management at the client terminal level.

According to some embodiments of the present invention, there are provided methods and systems of protecting the personal data of a user of a client terminal, such as a Smartphone, by blocking, editing, or delaying network traffic events which induce signaling events in a network, such as a cellular network. In use, network traffic events which are initiated by applications running on the client terminal are monitored and analyzed to identify which of these network traffic events includes personal data, for example advertisement (ad) requests. The analysis may be performed by classifiers and/or by contextual data that is gathered from the client terminal. This allows blocking, editing, or delaying network traffic events without affecting the quality of service given to other network traffic events of the applications installed in the client terminal.

The above results in reducing the load the respective cellular networks as an outcome of reducing the number of signaling events which are related to a transmission of sensitive personal data for ad personalization. The above results in reducing the drainage of the battery of the client terminal as the client terminal reduces the frequency of toggling between cellular radio states.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

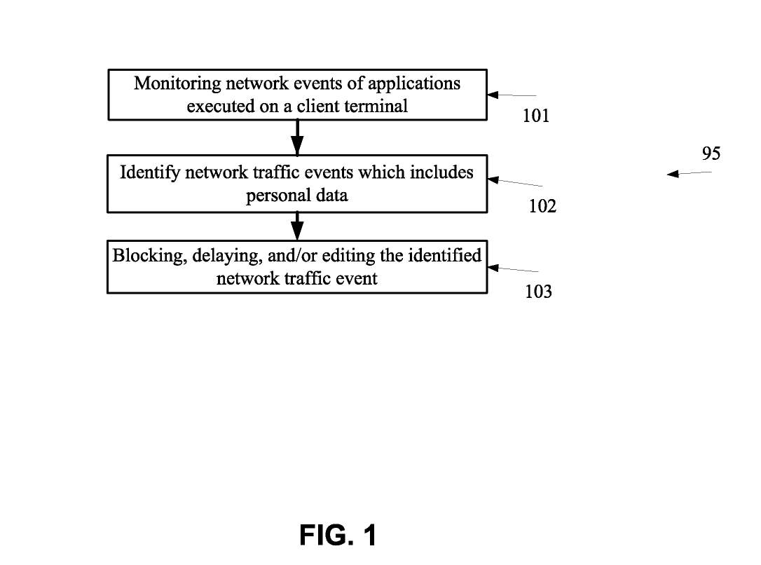

Reference is now made to FIG. 1, which is a flowchart of a method of blocking, editing, or delaying one or more network traffic events at a client terminal, such as a cellular device, which includes personal data about the user of the client terminal, according to some embodiments of the present invention. The blocked network traffic events may be uplink traffic events and messages which include personal data about the user and triggers signaling in a coverage area of the cellular network.

The method allows reducing the distribution of personal data by network traffic events of applications hosted on a client terminal, for example based on a classification of the network traffic events as related to ad requests. This control allows reducing the amount of data connections which are opened for signaling and traffic flows originated from client terminals per period while protecting the privacy of the user of the client terminal. The client terminal may be a cellular phone, a tablet, a router, a wearable device, a network connected node or object and/or any other processor based device.

As further described below, the method may be used to block, edit, or delay, for example by queuing, network traffic events of different applications hosted on a client terminal without requiring the classification of the applications themselves in advance. This allows protecting the privacy of the user without requiring from the user or from an external source to manually define each application. As further described below, the blocking is performed without affecting the quality of service (QoS) given to other network traffic events of the applications installed in the client terminal. As used herein, QoS refers to the capability of a network to provide better service to selected network traffic events over various technologies, including Frame Relay, Asynchronous Transfer Mode (ATM), Ethernet and 802.1 networks, SONET, and IP-routed networks that may use any or all of these underlying technologies. Optionally, the method allows aggregating network traffic events which includes personal data for a joint transmission in a common delayed signaling triggering event, namely under a common opening and closing of a data connection.

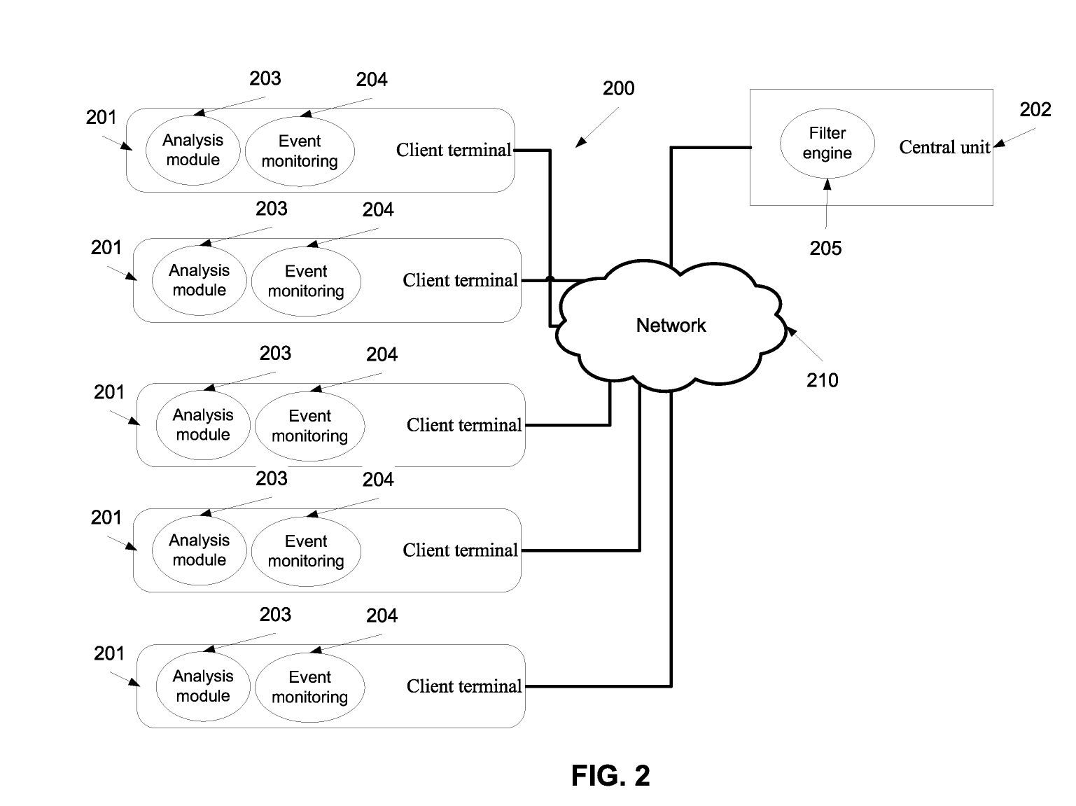

Reference is also made to FIG. 2, which is a schematic illustration of a system 200 of blocking, editing and/or delaying network traffic events with personal data at the client terminal level, for example ad requests, optionally using analysis modules 203 executed in a plurality of client terminals 201, according to some embodiments of the present invention. The analysis modules 203 may be hardware, firmware, or software modules, for example preinstalled in client terminals such as Smartphones and/or provided as part of an operating system (OS).

Optionally, the system 200 further includes a central unit 202, such as a network node, for example a server, which executes a filter engine 205 for generating filters and/or classifiers for the analysis modules 203, optionally based on data received from event monitoring modules 204 installed on the computing devices 201 via a network 210, for example network traffic events of applications which are installed thereon. The received data is aggregated and analyzed using various data mining and/or classification methods, for example as described in U.S. Provisional Patent Application which received the filing date of Jan. 30, 2014 and Ser. No. 61/933,366 and titled “NETWORK TRAFFIC EVENT MANAGEMENT AT THE CLIENT TERMINAL LEVEL”, by IDESES Ianir, et al., which is incorporated herein by reference.

FIG. 1 depicts a process 95 wherein network traffic events which includes personal data, such as name, cellular identity data, such as International mobile subscriber identity (IMSI), browsing data, such as browsing history, cookie based data, and the like, are continuously identified and delayed, edited and/or blocked in run time of a certain client terminal 201 at the certain client terminal 201 using the analysis module 203 for reducing privacy breaches and the number of data connections established by the certain client terminal 201 per period for transmitting personal data.

First, in use, as shown at 101, a plurality of network traffic events triggered by a plurality of applications executed on a client terminal are monitored by the analysis module 203. Optionally, a network event detector sub module is responsible for detection of new network traffic events in the network layer of the client terminal, for instance the layer that is responsible for packet forwarding and/or routing. The network event detector identifies network traffic events such as requests for new data connections. Requests may be for establishing data connections with accessories such as handset radios, data connections over a wireless local area network, such as over Wi-Fi, data connections over a Personal local area network, such as over Bluetooth™ and/or data connections over the cellular network.

Now, as shown at 102, the network traffic events are analyzed to identify network traffic events which trigger the sending of messages which encode or otherwise incorporate personal data. The analysis is optionally done by the analysis module 203, for example by a data context estimator sub module which estimates the type of each network traffic event triggered by applications on the client terminal 201 for transmitting. The analysis is optionally based on matching characteristics of the network traffic events with predefined rules or classifiers which are set as described in U.S. Provisional Patent Application which received the filing date of Jan. 30, 2014 and Ser. No. 61/933,366 and titled “NETWORK TRAFFIC EVENT MANAGEMENT AT THE CLIENT TERMINAL LEVEL”, by IDESES Ianir, et al., which is incorporated herein by reference.

Optionally, networking data generated by applications and based on a combination of prior data about hosts, network protocols, ports and other information is used to determine which network traffic events includes personal data, for instance by identifying the context of triggering the network traffic events. This context of a certain network traffic event may be identified by analyzing the activity the user performs on the client terminal, for example by checking which application is currently active and/or having a rendered graphical user interface. Additionally or alternatively, the context of a certain network traffic event may be identified by detecting a predefined pattern of data consumption held in the course of triggering the certain network traffic event, for example by a data consumption analyzing module that is installed in the client terminal 201. The predefined pattern of data consumption may be indicative of web browsing, a voice over IP (VOIP) session, a video streaming session, an audio stream session, a navigation session, an encryption process, an advertisement request, and/or the like. The purpose of this analysis is detection of ad related or sensitive information leakage related traffic or network events. For example, undesired events may include ad requests for presenting banners, video streams or images based on personal data of the user, such as exemplified above. Sensitive information may include information relating to the user, user accounts, user location, user preferences or information relating to the handset itself (IMEI, IMSI or any other data that can be then traced back to the user).

Optionally, network traffic events which encode or otherwise incorporate personal data are identified based on black and/or white lists. The network traffic events which encode or otherwise incorporate personal data may be deduced by black and/or white lists which document network protocols and/or applications. In such embodiment, the protocol and/or application of the network traffic event is identified and matched with the classification list(s) to perform the identification.

Optionally, network traffic events which encode or otherwise incorporate personal data are identified based on IP addresses range(s).

Optionally, network traffic events which trigger the transmitting of personal data are identified by any combination of the above identification processes, for example from black/white classification lists.

Optionally, network traffic events which trigger the transmitting of personal data are identified by identifying a network protocol known to be related to adware or transmission of sensitive information, for example from black/white classification lists.

Optionally, user actions, for instance user inputs, are monitored to detect user interaction and/or data logging for tracking potential leakage of sensitive information via network traffic events.

Optionally, network traffic events are classified as including or not including personal data by Neural Networks, Support Vector Machines or Nearest neighbor classifiers, see also U.S. Provisional Patent Application which received the filing date of Jan. 30, 2014 and Ser. No. 61/933,366 and titled “NETWORK TRAFFIC EVENT MANAGEMENT AT THE CLIENT TERMINAL LEVEL”, by IDESES Ianir, et al., which is incorporated herein by reference. Such classifiers may be trained in supervised or non supervised modes. In some embodiments the classifiers may be trained to detect and classify at the protocol level, at other embodiments the classifiers may be trained to detect at the application level.

As shown at 103, once a network traffic event is identified as including personal data, blocking, delaying, and/or editing thereof is held to prevent transmitting of the personal data and/or to prevent network signaling which is induced from such a network traffic event. The editing may include concealing the personal data, replacing the personal data with a public data (e.g. random data) and/or replacing it with fake personal data. Optionally, once a network traffic event candidate for blocking is identified, a network traffic event handler is triggered. The network traffic event handler may perform the blocking by blocking all communication with a related application, blocking all communication in a specific protocol, blocking network traffic events at the IP/host level or any combination of network traffic events that may be used to test compliance with a blocking pattern. The network traffic event handler parses information and proceeds to blocking the network events. Parsing may include extraction of destination host, destination port, inner protocol headers and may also include parsing of payload data. For example parsing the personal data being sent in order to identify it as such during user login authentication.

Blocking, delaying, or editing is performed at the basic networking stage to ensure that no personal data is sent beyond the operating system network stack and/or moved to via the physical layer to the cellular network.

The network traffic event handler may accept as input an application name for complete blocking, for example in the case where the application is deemed as intrusive adware. In other cases some of the network traffic events of an application are blocked, delayed, or edited so that some of its data is allowed to access the network whereas other types of personal data is blocked.

According to some embodiments of the present invention, periodic data transmissions of data packets, for example User Datagram Protocol (UDP) packets, are held over a communication network, such as a cellular network, in order to keep a respective radio network channel alive while network traffic events are being blocked. Optionally, the data transmissions are held separately from the blocking of the network traffic events. While the network traffic events are blocked are described above, the periodic data transmissions are held to keep the radio network active, for example without any logic analysis of the data flow (e.g. at a data link layer) and/or without any triggering that is based on the blocking of the network traffic events. For example, during the monitoring of the network traffic events, network packets to and/or from the client terminal 201 are tracked and classified into originating data stream (e.g. transmission control protocol (TCP) connection, or user datagram protocol (UDP) stream). A record of the tracked data is stored at least until the last packet of the originating data stream is transmitted upstream. Optionally, record(s) of when the last Domain Name Service (DNS) request is sent and when the last DNS response are received and stored. Optionally, a record of the time when the next packet should be sent off the queues is stored. The time differential between all packets (be it TCP, or UDP) is measured to allow calculating an average traffic rate. The average traffic rate, the time when the next packet should be sent off the queues, and the record(s) of when the last Domain Name Service (DNS) request is sent and when the last DNS response are received are combined to predict when the next packet is going to be sent/received over the device radio network. Prediction process is based on a predefined temporal decision tree, optionally while taking into account a heuristical model of communication networks behavior.

The above calculated predication is used to decide whether an active state of the radio network channel should be maintained or left to drop to an IDLE state whenever a packet is sent out from the client terminal. This decision may be based on weighting user responsiveness of the client terminal against battery life, amount of signaling that would be reduced by extending the active state and/or the like.

When a decision to extend the active state is received, small UDP packets are periodically transmitted in order to keep the radio state of the client terminal alive in an energy conserving active state, for example FACH in 3third generation (3G). The periodic transmission remains until the predicted next-packet time and then optionally stopped.

The above prediction and signal extension process may be performed on each new packet destined upstream so that the prediction is reset and recalculated on each new packet, followed by the above process.

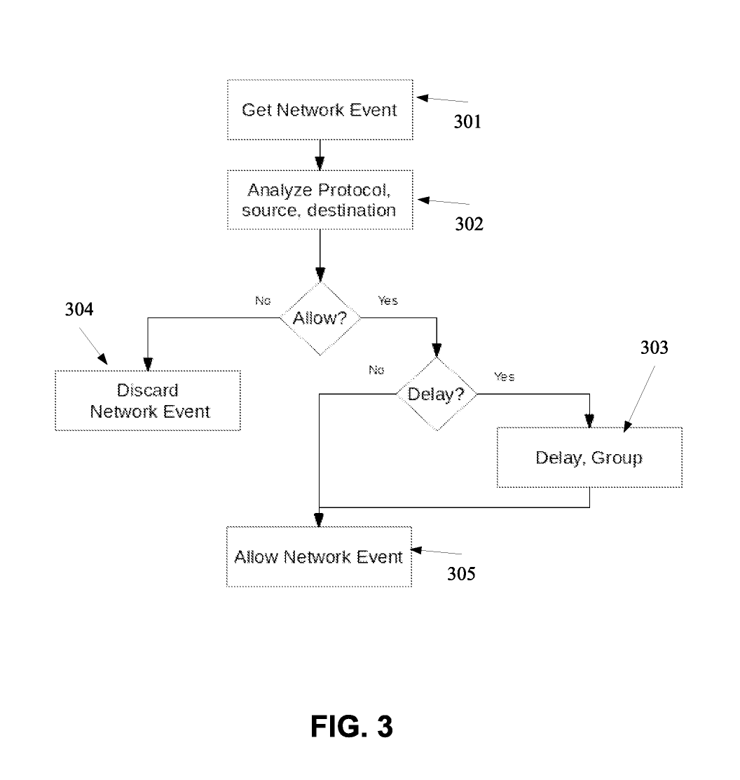

FIG. 3 depicts a dataflow wherein a network traffic event, marked as a network event, is captured 301, analyzed 302 and either ignored 304 or handled as a network traffic event having personal data about the user of the client terminal 201 according to some embodiments of the present inventions. In this flow, the network traffic events which are identified as having personal data are delayed 303 before being allowed 305 for transmission. Similar processes may be employed where the delay is replaced with editing functions and/or blockage.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and devices will be developed and the scope of the term a unit, a module, and a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of blocking or editing network traffic events on a client terminal, comprising:
monitoring, in run time, a plurality of network traffic events triggered by a plurality of applications executed on a client terminal for transmitting data via a cellular network;
analyzing said plurality of network traffic events to identify thereamong at least one undesired network traffic event for transferring personal data which describe at least one characteristic of a user associated with said client terminal over a network; and
performing at least one of blocking and editing said at least one undesired network traffic event to prevent transmitting of said personal data via said cellular network.

2. The method of claim 1, wherein said at least one undesired network traffic event is a network traffic event for triggering the transmission of said personal data in an advertisement request.

3. The method of claim 1, wherein said plurality of network traffic events are messages for opening a data connection over a cellular network.

4. The method of claim 1, wherein said client terminal is a cellular device and said network is a cellular network.

5. The method of claim 1, wherein said at least one undesired network traffic event is blocked by capturing packets of said at least one undesired network traffic event before the transmission thereof.

6. The method of claim 1, wherein said personal data comprises at least one of a name of said user, cellular identity data of said user, browsing data of said user, and cookie based data.

7. The method of claim 1, further comprising analyzing a context of each of said plurality of network traffic events by identifying an activity said user on said client terminal; wherein said identifying is performed according to said context.

8. The method of claim 1, further comprising analyzing a context of each of said plurality of network traffic events by identifying a predefined pattern of data consumption by said client terminal; wherein said identifying is performed according to said context.

9. The method of claim 1, wherein said identifying is performed according to a classification list which includes a plurality of records each said record defines at least one of a communication protocol classification, an application classification, and a traffic event classification.

10. The method of claim 1, wherein said identifying is performed according to a statistical classifier.

11. The method of claim 1, wherein said at least one undesired network traffic event is edited to conceal said personal data before the transmission thereof.

12. The method of claim 1, further comprising establishing an artificial connection alive to maintain communication channel designated for transmitting said at least one undesired network traffic event alive.

13. A computer readable medium comprising computer executable instructions adapted to perform the method of claim 1.

14. A device of blocking or editing network traffic events on a client terminal, comprising:
a monitoring module which monitors, in run time, a plurality of network traffic events triggered by a plurality of applications executed on a client terminal for transmitting data via a cellular network;
an analysis module which analyzes said plurality of network traffic events to identify thereamong at least one undesired network traffic event comprising personal data characterizing a user of said client terminal as said data; and
a network traffic event handling module which performs at least one of blocking and editing said at least one undesired network traffic event to prevent transmitting of said user defining data via said cellular network.

15. A computer program product for blocking or editing network traffic events on a client terminal, the computer program product comprising a computer readable storage medium having program instructions embodied therewith, the program instructions executable by a processor of a client terminal to cause the processor of the client terminal to:
monitor, in run time, a plurality of network traffic events triggered by a plurality of applications executed on a client terminal for transmitting data via a cellular network;
analyze said plurality of network traffic events to identify thereamong at least one advertisement network traffic event for transferring personal data which describe at least one characteristic of a user associated with said client terminal over a network; and
calculate instructions to perform at least one of blocking and editing said at least one advertisement network traffic event to prevent transmitting of said personal data via said cellular network.
